(19) United States
(12) Patent Application Publication
(10) Pub. No.: US 2020/0230987 A1
(43) Pub. Date: Jul. 23, 2020

(54) HAND STAMP

(71) Applicant: COLOP STEMPELERZEUGUNG SKOPEK GESELLSCHAFT M.B.H. & CO. KG., Wels (AT)

(72) Inventor: Ernst FABER, Wels (AT)

(73) Assignee: COLOP STEMPELERZEUGUNG SKOPEK GESELLSCHAFT M.B.H. & CO. KG., Wels (AT)

(21) Appl. No.: 16/633,672

(22) PCT Filed: Jul. 27, 2018
(86) PCT No.: PCT/AT2018/060166

§ 371 Date: Jan. 24, 2020

(30) Foreign Application Priority Data
Jul. 27, 2017 (AT) A 50628/2017

(51) Int. Cl. B41K 1/12

(52) U.S. Cl. CPC B41K 1/12

(57) ABSTRACT

A hand stamp has a stamp plate which has a static cliché and has an adjustable type assembly which has different printing characters, the static cliché of the stamp plate having a two-dimensional stamp code, and the type assembly having a bridge with a supporting face, which supporting face is provided to support a printing character, set for a stamp impression, of an adjustable type strip of the type assembly, and the extent of the width of which in the adjustment direction of the type strip is greater than the extent of the printing character in the same direction.

The invention relates to a hand stamp, in particular a self-inking stamp with inking in an upside-down position, comprising a stamp plate having a static cliché and comprising an adjustable type assembly having different printing characters, wherein the static cliché of the stamp plate has a two-dimensional stamp code.

The invention additionally relates to a method for producing a marking which serves as the authentication of an object on the object using such a hand stamp.

The hand stamp can, for example, be a self-inking stamp, a non-self-inking stamp, possibly also an electronic stamp or the like.

Hand stamps comprising a stamp plate with a static cliché and an adjustable type assembly having different printing characters are known. Here the static cliché serves to apply invariable information, for example, a company name or a logo onto a document whilst the adjustable type assembly makes it possible to apply variable information such as an adjustable date. Frequently such stamped documents are signed by hand in order to confirm the content of the document. The printing relief of a character or symbol is designated as printing character, where a stamp impression of the inked printing character produces a representation of the relevant character or symbol on a substrate. In the case of a hand stamp of the specific type here with an adjustable type assembly, a stamp impression comprises imprints of the static cliché and of only a part of the different printing characters depending on a setting of the adjustable type assembly. That is, the setting of the adjustable type assembly specifies which printing characters are arranged in an imprint plane of the hand stamp and consequently form a part of the imprint area of the hand stamp, which comes in contact with the substrate when producing a stamp impression.

DE 10 2014 001 355 A1 discloses a programmable stamp which can apply variable information in a machine-readable manner as stamp impression. The stamp has a stamp image which consists at least partially of a matrix field with a plurality of image elements in a predefined arrangement. At least a part of the image elements is displaceable via at least one actuator from a passive position in which the image elements do not produce a stamp impression into an active position and can be fixed in the active position by means of a holding device to produce the stamp impression. In the active position the image element projects from the front plane of the matrix field. The stamp image can, for example, comprise a QR code.

However, the programmable stamp has a complex structure and is cumbersome to handle. In addition, the programmable stamp has no stamp plate with a static cliché. As a result, the impressions of a stamp, apart from the setting of the displaceable image elements cannot be distinguished from the impressions of other stamps.

In addition, methods for producing a marking on an object which serves to authenticate an object are known.

DE 10 2007 050 691 A1 discloses a random marking of print products in a method for determining authenticity in which characteristic features of the printing method or the print substrate are detected within a printed code. In this case, at a location of the fabrication process of a packaging, random characteristics of the printing process and/or the paper structure are recorded by means of an image recording device, analyzed and encoded in a subsequent processing step and stored as code, encrypted and unencrypted, for example, in a database. Thus, the print and substrate structure is used as an individual characteristic for the identity and authenticity of a product. The printed code can be a 2D matrix code or an arbitrary redundant sequence of symbols, for example, of letters of a defined font.

A disadvantage of this method is the complexity which results from the detection and processing of random characteristics of the printing process or the paper structure.

JP 2002150212 A discloses a hand stamp to produce a stamp impression which can be read by persons and which is machine-readable. At one of its ends the hand stamp has a stamp region A with a static text which can be read by a person in an upper section B, a machine-readable two-dimensional static code in a middle section C and adjustable date types in a lower section D.

The hand stamp thus enables only one setting of a date. However, date information is unsuitable to distinguish between products which, for example, have been produced on the same day. In particular, date information is not suitable or only inadequate for use as an authentication feature (i.e. for checking the genuineness of a marking).

JP 2016221820 A relates to a different type of hand stamp which has no adjustable type assembly and also cannot produce any authentication feature.

It is now the object of the invention to provide a hand stamp as specified initially which makes it possible to apply a stamp image to an object, for example, a document or a three-dimensional body, for reliable subsequent authentication of the stamped object by a user in a simple manner. The hand stamp should be cheap to manufacture and easy to handle.

It is also the object of the invention to provide a method as specified initially which makes it possible to produce and process the marking on the object used for authentication of an object in the simplest and most cost-effective way for a user using a hand device.

For this purpose the invention provides a hand stamp as defined in claim 1 and a method as defined in claim 8. Advantageous embodiments and further developments are specified in the dependent claims.

According to the invention, it is provided that the type assembly has a bridge with a supporting face, which supporting face is provided to support a printing character, set for a stamp impression, of an adjustable type strip of the type assembly, and the width extension of which in the direction of adjustment of the type strip is greater than the extension of the printing character in the same direction. The two-dimensional stamp code contains information, in particular coded information which serves to verify the authenticity of the object. For this purpose the two-dimensional stamp code can contain letters, numbers and/or symbols. In particular, the two-dimensional stamp code can contain encoded letters, numbers and/or symbols. The static cliché which is a fixed printed pattern or printed relief is formed by the stamp plate of the hand stamp. The fact that it comprises a two-dimensional stamp code means that the two-dimensional stamp code is represented by the static cliché. Consequently, a stamp impression of the two-dimensional stamp code also corresponds to a representation of the two-dimensional stamp code. In contrast to known hand stamps in which the static cliché comprises lettering which is immediately identifiable for a user, for example, a company name, the two-dimensional stamp code can contain information which is not immediately identifiable. By means of suitable coding of the information contained in the static cliché, the security with respect to counterfeits of the stamp impression can be enhanced since a counterfeiter does not know which information should be contained in the static cliché and how this information should be encoded. A suitable coding can, for example, comprise an encryption with a private code. The hand stamp additionally has an adjustable type assembly with different printing characters in order to be able to stamp different objects with printing characters which differ from one another. The adjustable type assembly is provided in order to be able to stamp different objects which carry the same two-dimensional stamp code with different printing characters. In this way, the different objects with the same stamp code can be distinguished. For a unique verification of each object it is expedient to use the information applied with the adjustable type assembly only once for one and the same static cliché. However, since the hand stamp is used to apply a marking used for authentication of the object to the object, knowing the type of object, information applied with the adjustable type assembly already used for a different type of object can possibly be reused on different types of objects which can be distinguished by the user. The adjustable type assembly is preferably adjustable manually by a user, for example, by means of adjusting wheels. The printing characters of the adjustable type assembly used to produce a stamp impression depend on the setting thereof; i.e. according to the setting of the adjustable type assembly, a stamp impression of different printing characters is produced on the object. The different printing characters of the adjustable type assembly can, for example, be arranged on one or more adjustable type carriers. The type carriers can, for example, be type strips, type wheels or sliders which are movable relative to the stamp plate. As already mentioned, the object can be a substantially two-dimensional object, for example a document or a substantially three-dimensional object compared to this having significant extensions in all three spatial dimensions. The hand stamp is preferably configured to apply both the static cliché and also the information applied with the adjustable type assembly to the object in a single actuation process by the hand stamp. The static cliché or the stamp plate can be arranged next to the printing characters of the adjustable type assembly. Alternatively the stamp plate can surround the adjustable printing characters so that the printing characters in the stamp impression are provided inside the static cliché. Although the two-dimensional stamp code is a set of characters which can be interpreted by the user only by decoding the stamp code, the two-dimensional stamp code can naturally also contain characters which can be read directly by a user without decoding the stamp code.

The bridge (also “web”) designates a part of the type assembly on which the at least one adjustable type strip abuts so that the supporting face of the bridge is disposed on the rear side of the printing character of the type strip set for the impression. The bridge thus forms a bearing for the type strip which presses the abutting portion of the type strip together with a printing character against the substrate when creating an impression. Since an inspector manipulates the printing characters stamped on the object, the inspector could obtain undesired access to digital representations of arbitrary other objects with the same stamp code without suitable countermeasures in an inspection process manipulated in such a manner. In order to make this undesired access more difficult, a comparison of the object having the stamp impression with digital representations by the inspector is only permitted when the stamp impression has been successfully authenticated.

A successful authentication of a stamp impression produced with the hand stamp can, for example, depend on whether a software program provided for the authentication ascertains that the positions of the printing character of the type strip in the stamp impression agrees with a position of the printing character of the type strip deposited when registering the stamp impression, i.e. the position of the printing character of the type strip in the digital representation. In this case, the position of the printing character of the type strip is considered in relation to the static cliché. For this purpose, the type assembly has a bridge or a web with a supporting face whose width extension in the circumferential direction of the type strip is greater than the extension of the printing character in the same direction. Thus, different positions of the printing character on the supporting face in the direction of the width extension of the supporting face can be set by the user of the hand stamp. The type assembly is preferably configured for the setting of at least two different positions of the character or the printing character in the direction of the width extension of the supporting face. In order to facilitate the detection of the set position of the character, a scaling can be provided on the supporting face or on the bridge. Particularly preferably, the type assembly is configured for a continuous setting of the position of the character or the printing character in the direction of the width extension of the supporting face.

According to a preferred embodiment of the invention, the two-dimensional stamp code can represent a unique user identification. The user identification is uniquely assigned to the user of the hand stamp, i.e. the producer of the stamp impression. Thus, the stamp impression produced on the object with the hand stamp is uniquely assigned to a user. The user of the hand stamp can either seek his user identification himself or the user identification is allocated in a preferred variant by a manufacturer of the hand stamp or by another authorized person. In any case, an allocation of the same user identification for different users is avoided. However, several hand stamps of the same user can carry the same user identification. The user identification can in this case contain substantially arbitrary information that can be encoded with the two-dimensional stamp code such as a user name, company name or letters, numbers, symbols or a combination thereof. Together with a stamp impression of the adjustable type assembly, the user identification enables an unambiguous marking of an object so that the user identification together with the stamp impression of the adjustable type assembly can be uniquely related to an object. By means of such a unique relation, for example, additional information on the object can be retrieved from a central database, e.g. a digital representation of the object (scan of a document or photograph of a product) or data relating to the authentication of the object (possibly relating to a location and/or time of creation or registration of the object).

In order to enable an inspector to be able to check the authenticity of an object which carries a stamp impression produced with the hand stamp, it is expedient if the static cliché additionally has a two-dimensional application code which differs from the two-dimensional stamp code. The two-dimensional application code contains information required for carrying out the inspection process and can be detected for this purpose by the inspector carrying out the inspection by means of a suitable reading device and a suitable software program and can be processed by the software program. In particular, the software program contains instructions for a universal reading device (e.g. a smartphone or tablet PC, in each case with a camera) in order to instruct this to carry out an inspection process using the stamp code. The two-dimensional application code and the two-dimensional stamp code can be disposed on the same stamp plate or, in an equivalent embodiment, on a respectively dedicated stamp plate of the hand stamp.

It is favourable if the two-dimensional stamp code and/or the two-dimensional application code is a two-dimensional machine-readable character code, in particular a matrix code, preferably a QR code. In the general case, the two-dimensional machine-readable character code comprises punctuate, linear and/or extensive symbols which differ from characters. If the two-dimensional machine-readable character code is advantageously known from the prior art, suitable, likewise known software programs which can be applied cost-effectively can be used for generating or encoding and for the processing or decoding of the stamp code and/or application code. It is favourable if the two-dimensional machine-readable character code is a standardized code. The two-dimensional machine-readable character code can be detected in a simple manner by means of a suitable reader, for example, a smartphone comprising a camera and suitable processing software. In particular as matrix code, preferably QR code the character code can be easily detected both by the user of the hand stamp and also by an inspector.

For examining the originality of an object which bears a stamp impression produced with the hand stamp, it is particularly favourable if the two-dimensional application code represents an internet address. Preferably a software program is stored or referenced under the internet address (e.g. in an “App store” or “Play store”) which enables the decoding of the two-dimensional stamp code and evaluation of a stamp impression of the adjustable type assembly and for comparison purposes, releases the detection of a digital representation of the object having the stamp impression. In this case, the user identification under which the digital representation of the object was stored by the user of the hand stamp and linked to a setting or an impression of the adjustable type assembly is determined from the two-dimensional stamp code in order to enable a comparison of the digital representation with the object by an inspector. For example, by means of the software program stored under the internet address, the digital representation of the object assigned to the stamp impression is represented on a smartphone of the inspector.

In order to be able to easily distinguish different positions of the same printing character on different stamp impressions with reference to the static cliché, it is advantageous if the width extension of the supporting face is at least 1.5 times as large, preferably at least twice as large as the extension of the printing character in the same direction. In this way, an expediently extended region for the arrangement of the printing character at a selected position of the supporting face is created.

In order to be able to distinguish an expediently large number of objects with the same two-dimensional stamp code by means of the printing characters, it is favourable if the type assembly has at least two, preferably at least four independently adjustable type carriers, in particular with numbers and/or letters as printing characters. Preferably the type assembly has two, three, four, five or six such adjustable type carriers. For example, 10 000 objects having the same two-dimensional stamp code can be distinguished with a type assembly having four adjustable type carriers each having numbers from 0 to 9.

According to the invention, a method is also provided for producing a marking serving to authenticate an object on the object, using a hand stamp according to the preceding description, wherein the method comprises:
setting at least one printing character of the type assembly for a stamp impression;
producing a stamp impression of the static cliché and the at least one set printing character on the object;
creating a digital representation of the object having the stamp impression;
registering a combination of the static cliché with the at least one set printing character and linking the registered combination with the created digital representation.

In the method for producing a marking on an object which marking is used to authenticate the object, the marking is applied to the object in the form of a stamp impression by a user using a hand stamp. The hand stamp comprises a stamp plate with a static cliché and an adjustable type assembly with different printing characters. In particular, the hand stamp is configured according to the preceding description which is why the features of the hand stamp are not repeated for the description of the method. The printing character of the type assembly which makes it possible to distinguish objects having the same stamped-on static cliché is set on the hand stamp by the user of the hand stamp. The setting of the at least one printing character can, for example, comprise an individual setting of several printing characters such as, for example with a continuous numbering. An individual setting means in this context that with each repetition of the method for producing a marking the setting of the one or more printing character(s) is changed so that each marking produced differs from the marking produced previously with the same hand stamp (and therefore is “individual”). The choice of printing character can be made by the user himself, wherein this user will ensure that the object is stamped only once with the printing character, in particular a combination of printing characters of the type assembly. Since in the subsequent registration step of the method, the printing character set for an executed stamping process is detected in any case, when selecting the printing character, i.e. when avoiding an unintended reuse of a printing character, the user can be assisted by a software program used for the registration. For example, after inputting the printing character(s) provided for the setting on the type assembly, the software program can output an error message if the printing character(s) have already been registered previously, i.e. used. Alternatively the software program itself can propose the printing character(s) to be set wherein the software program is then configured to propose only un-registered printing character(s).

After setting at least one printing character of the type assembly by the user, a stamp impression (imprint) of the static cliché and the at least one set printing character is produced on the object by the user by means of the hand stamp. A digital representation, preferably a digital optical image, of the object having the stamp impression, i.e. also of the stamp impression itself is then created by the user. For this purpose, the object can, for example, be scanned in or photographed. Within the framework of the method described however, features of the object other than those which can be detected optically can also be detected digitally additionally or alternatively to the optically detectable features and used as digital representation insofar as these are suitable for distinguishing objects. For example, from a document comprising several pages, only a single page can be provided with the stamp impression and used as digital representation together with an additional feature of the document such as the number of words or a check sum calculated from the text. In each case, the digital representation for the object and the stamp impression comprises characteristic digital data.

After a digital representation of the object having the stamp impression has been created, a combination of the static cliché with the at least one set printing character is registered by the user and the registered combination is linked to the created digital representation. For registration of the said combination, the static cliché and the at least one set printing character can be stored on a storage medium, in particular entered into a database. In addition, the created digital representation of the object, e.g. in the form of an image and/or other digital data, can be stored on the storage medium or entered in the database and thereby assigned to the registered combination. In this way, a unique linking of the static cliché with the at least one set printing character and the digital representation of the object is created. Here it is favourable if an address region is specified on the storage medium, in particular in the database in which the digital representation of the object is stored by the combination of static cliché and printing character. A user-friendly user interface for input of the static cliché and optionally data assigned to the static cliché such as a check sum of the at least one set printing character and the digital representation of the object is preferably provided by a software program provided for the registration.

According to a preferred embodiment of the method, when registering, a user identification assigned to the static cliché is linked to a digital representation of the set printing character. Accordingly, for registration the user can store his user identification uniquely assigned to him in the storage medium or enter it into the database. This saves entering the static cliché also uniquely assigned to the user in the form of its digital representation, e.g. as a digital image. For example, the user is provided with his unique user identification which can comprise letters, numbers and/or special characters, jointly with the hand stamp.

In order to avoid misuse, i.e. unallowed registration by users not provided for registration, it can be provided that before registering an authorization linked to the static cliché (or the assigned user identification) is checked for registering new connections with set printing characters. Accordingly by means of static cliché s given by the user during registration, preferably by the software program provided for registration, it is checked whether the user is authorized to register a combination of the static cliché with at least one set printing character.

The method can additionally comprise the following steps:
generating and displaying a specification of the at least one printing character of the type assembly to be set,

wherein the setting of the at least one printing character takes place according to the displayed specification,

wherein during registering a combination of the static cliché with the generated specification of the printing character is registered. In this way, it is not necessary for the user himself to select at least one printing character and possibly take care to use only printing characters not used so far for the registration. Instead, a specification of the at least one printing character of the type assembly to be set, can be generated, for example, by the software program used for registration and displayed to the user. For this purpose, the software program is advantageously configured to propose only unregistered printing character(s). In this case, the specification of the printing character is generated depending on the static cliché. Expediently the user sets the at least one printing character corresponding to the displayed specification and registers the combination of the static cliché with the generated specification of the printing character.

In order to make it difficult for an inspector to have undesired access to objects other than that which is characterized by the at least one printing character, it is favourable if during setting both the printing character of the type assembly and also the position of the set printing character in the impression relative to the static cliché are set, wherein at least the position of the set printing character is randomly specified. Accordingly, the user of the hand stamp can set the at least one printing character and an arbitrary, randomly selected position of the at least one printing character relative to the static cliché. Thus, the registered printing characters may be guessed by an inspector, but they are unlikely to guess the randomly set position of the at least one printing character. Naturally each printing character can be set with a different position relative to the static cliché. When examining an object for authenticity, the digital representation of an object will only be displayed to the inspector for comparison purposes if the position of the at least one printing character in the stamp impression on the real object agrees with the position of the printing character in the digital representation of the object. The comparison of the positions is made by a software program.

In order to make it difficult for an inspector to have undesired access to objects other than that which is characterized by the at least one printing character, it is also favourable if during registering the position of the set printing character in the impression relative to the static cliché is registered. This simplifies the comparison of the position of the at least one printing character in the stamp impression on the real object with the position of the printing character in the digital representation of the object since the position of the printing character in the digital representation of the object had already been notified during registration and need to be determined only from the digital representation. Such a comparison makes it possible to authenticate the stamp impression before any authentication of the object.

The invention further relates to a method for checking an object with a stamp impression for authenticity (authentication of the object), wherein the stamp impression is a stamp impression produced with a hand stamp as described above or produced according to a method as described above. This authentication process enables an inspector to compare the object with the digital representation of the object, wherein the digital representation, as described previously, is linked to the registered static cliché which can be assigned a user identification and the registered printing characters of the stamp impression. In particular, the digital representation of the object can be stored in a memory region of a database which is specified by the registered combination of the static cliché with the at least one set printing character. If the inspector would like to determine the authenticity of the object in an inspection process, the inspector creates an image of the stamp impression with the static cliché, for example, by scanning in or digital photographing of the stamp impression. If the two-dimensional application code of the static cliché represents an internet address, a software program stored under the internet address can provide a checking software provided for checking or contain a reference to a corresponding software program. By means of the checking software, the image of the stamp impression created by the inspector can be further processed. Preferably in this case the stamp impression of the two-dimensional stamp code and the stamp impression of the at least one printing character of the stamp impression is identified and by means of the identified data, a database interrogation is carried out for a registered combination of the stamp code and the at least one printing character. If at least one registered combination can be determined, a digital representation of the object linked thereto is interrogated and displayed to the inspector, on a display device, for example, a smartphone. The inspector can now determine by comparison with the object whether the object corresponds to the displayed digital representation and thus check the authenticity and genuineness of the object.

By manipulating the printing characters of the stamp impression, for example, by sticking over the printing character with other printing characters, the inspector could obtain access to that address region which is assigned to the combination of the two-dimensional stamp code and the manipulated printing characters. Thus, the inspector could specifically examine a different object. In order to avoid this, the type assembly for example can have the previously described bridge with the supporting face. Thus, the user of the hand stamp can not only set the printing characters but also the position of the printing characters, preferably randomly. Since the inspector does not know the position of the printing characters on an object not provided to him, an attempt at manipulation will fail. For this purpose the checking software compares the position of the possibly manipulated printing characters with the position of the registered printing characters and only displays the object when they agree.

The invention relates quite generally to a hand stamp with an adjustable type assembly (with or without a stamp plate having a static cliché), wherein the adjustable type assembly comprises at least one adjustable type strip with different printing characters, wherein the hand stamp is characterized in that the type assembly has a bridge with a supporting face, which supporting face is provided to support a printing character set for a stamp impression of the at least one adjustable type strip of the type assembly, wherein a width extension of the supporting face in the direction of the adjustment of the type strip is greater than the extension of the printing character in the same direction, in particular is at least 1.5 times greater, preferably at least twice as great.

The invention will be further explained hereinafter with reference to preferred non-restrictive exemplary embodiments with references to the drawings. In the figures:

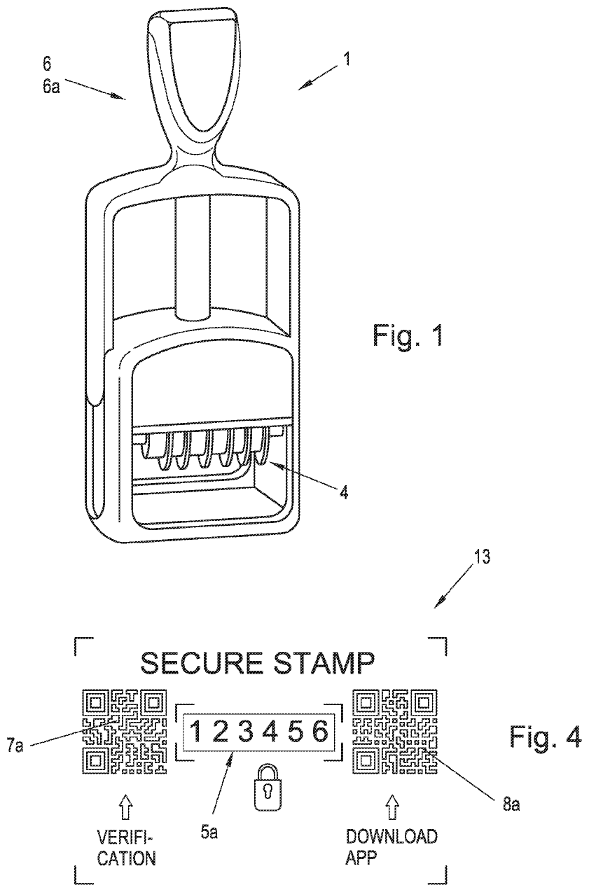

FIG. 1 shows a hand stamp according to the invention;

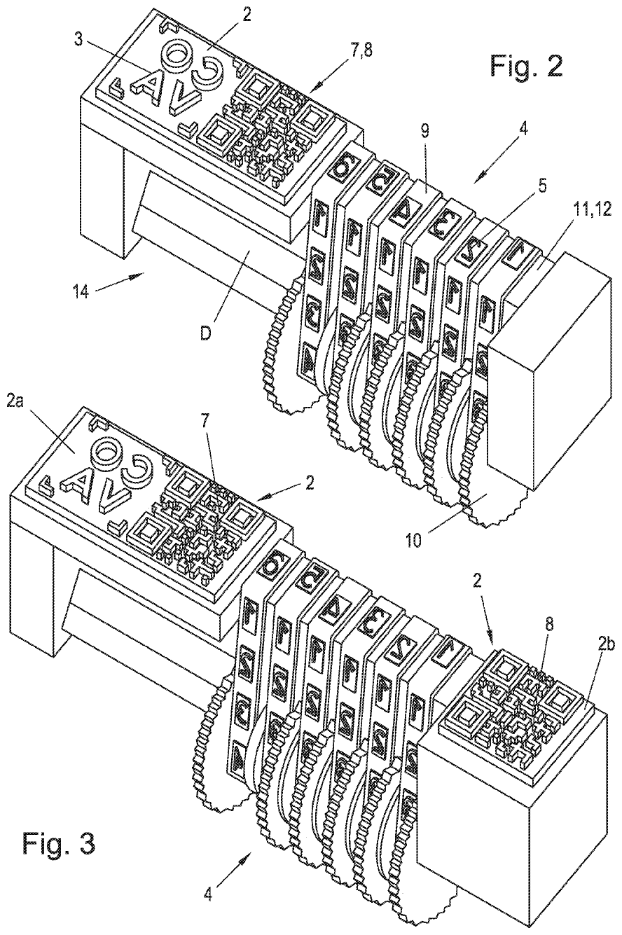

FIG. 2 shows a stamp unit of the hand stamp from FIG. 1 with a one-part stamp plate having a static cliché and with an adjustable type assembly having different printing characters;

FIG. 3 shows a variant of the stamp unit from FIG. 2 with a two-part stamp plate having a static cliché and with an adjustable type assembly having different printing characters, wherein a part of the stamp plate comprises a two-dimensional stamp code and the other part of the stamp plate comprises a two-dimensional application code;

FIG. 4 shows a stamp impression produced with the stamp unit from FIG. 3;

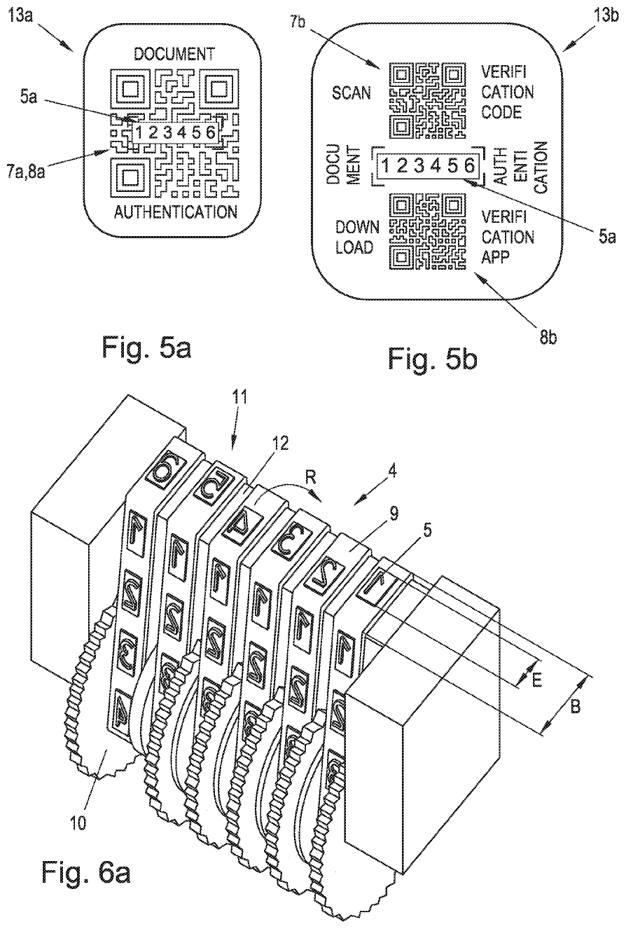

FIG. 5a and FIG. 5b show alternative embodiments of stamp impressions which can be produced with a hand stamp according to the invention;

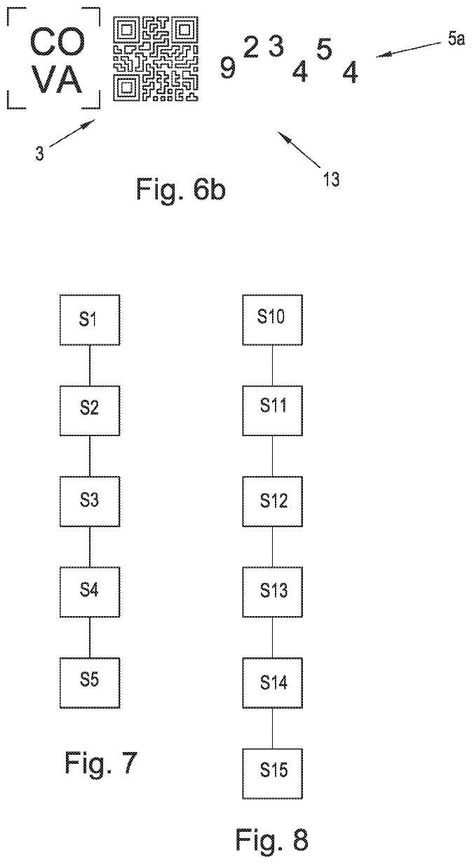

FIG. 6a shows a stamp unit for a hand stamp with an adjustable type assembly which has a bridge with a supporting face and several type strips, wherein the width extension of the supporting face in the direction of an adjustment of the type strips is greater than the extension of the individual printing characters of the type strips in the same direction;

FIG. 6b shows a stamp impression which is produced with printing characters offset with respect to one another and with a static cliché;

FIG. 7 shows a flow diagram with process steps carried out by a user of the hand stamp to produce a marking on the object used to authenticate an object; and

FIG. 8 shows a flow diagram with process steps carried out by an inspector to authenticate a marked object.

FIG. 1 shows a hand stamp 1 which comprises a stamp plate 2, not visible in FIG. 1, with a static cliché 3 and an adjustable type assembly 4 with different printing characters 5, cf. in particular FIG. 2. The hand stamp 1 is a self-inking stamp with inking in an upside-down position. The hand stamp 1 can, as is known per se, be configured in various embodiments and preferably has an actuating part 6, for example, a handle 6a, for actuating the hand stamp 1. By moving the actuating part 6 from the depicted exemplary rest position downwards into an impression position towards a substrate to be stamped, in particular towards an object to be stamped, the stamp plate 2 and the type assembly 4 can be pressed towards the substrate or towards the object.

FIG. 2 shows a stamp unit 14 of the hand stamp 1 from FIG. 1 with the stamp plate 2 and the type assembly 4 relative to a rest position of the hand stamp 1 in a view from below onto an imprint surface, wherein the stamp plate 2 has a static cliché 3 with a two-dimensional stamp code 7. The two-dimensional stamp code 7 preferably represents an encrypted and unique user identification. The static cliché 3 can additionally comprise a two-dimensional application code 8 which differs from the two-dimensional stamp code 7. The two-dimensional application code 8 preferably represents an internet address. The two-dimensional application code 8 can be arranged according to FIG. 2 on the same stamp plate 2 as the two-dimensional stamp code 7 and can be configured to be substantially one-part or jointly with the stamp code 7 so that the stamp code 7 and the application code 8 appear as a single two-dimensional code when observed visually (geometrically).

The two-dimensional stamp code 7 and/or the two-dimensional application code 8 can, as can be clearly deduced from FIG. 2, be a two-dimensional machine-readable character code, in particular a matrix code, preferably a QR code. The two-dimensional stamp codes mentioned within the framework of this description are also known as 2D codes. The static cliché 3 of the stamp plate 2 can comprise a stacked code, a matrix code, a point code or another known two-dimensional stamp code, but a matrix code, in particular a QR code is preferred.

The type assembly 4 with different printing characters 5 can be additionally identified in FIG. 2. The printing characters 5 are arranged on six adjustable type strips 9 in particular running around an axis of rotation D of the type assembly 4, wherein adjusting wheels 10 coupled in a torque-proof manner therewith are provided for the adjustment of the type strips 9. The type assembly 4 has a bridge 11 with a supporting face 12, so that by turning the adjusting wheels 10 the printing characters 5 of the individual type strips 9 exposed with respect to the supporting face 12 can be selected.

FIG. 3 shows a two-part stamp plate 2 with a static cliché 3 and a type assembly 4 in a view from below as a stamp unit of an alternatively configured inventive hand stamp 1. Here a first part 2a of the stamp plate 2 comprises the two-dimensional stamp code 7 and a second part 2b of the stamp plate 2 comprises the two-dimensional application code 8.

FIG. 4 shows a stamp impression 13 produced with a hand stamp 1 according to the invention. As described previously, this is applied by a user of the hand stamp 1 to an object not depicted in FIG. 4 after setting the type assembly 4. The user then deposits a digital representation of the object with the stamp impression 13 in a data memory or in a database whereupon after detecting the stamp impression 13 of an object to be checked for authenticity, an inspector obtains an insight into the digital representation of the object identified with the stamp impression 13. The stamp impression 13 comprises an impression 7a of the stamp code 7, an impression 8a of the application code 8 and an impression 5a of the set printing characters 5 of the adjustable type assembly 4. In the depicted example the printing character of the numbers 1 to 6 are set on the adjustable type assembly. Assuming that the six type carriers for the six digits of the type assembly each comprise ten different printing characters (“0” to “9”), 1,000,000 different settings of the type assembly (“000000” to “999999”) are possible so that a corresponding number of objects can be clearly marked and clearly authenticated. Furthermore, the stamp impression comprises references to the use of the stamp impression for authentication and validation of the object carrying the stamp impression.

FIG. 5a shows a stamp impression 13a produced with a hand stamp 1 according to the invention with a single QR code which contains the impression 8a of the application code 8 and optionally the impression 7a of the stamp code 7. This embodiment has the advantage that an inspector cannot be confused by the presence of two different QR codes, namely the impression 7a and the impression 8a in one stamp impression 13. In this example, the impression 5a of the printing characters 5 is surrounded by the impression of the static cliché 3. If the stamp impression 13a comprises no impression of a stamp code 7, a unique user identification is also lacking. In this case, the setting of the type assembly 4 must be unambiguous for all users of such a hand stamp (e.g. identifiable from a specific static cliché, e.g. with an application code) if a unique marking is desired or necessary. This can be achieved, for example, if the setting of the adjustable type assembly is predefined from a central location (e.g. a central web service). This central location then ensures that as far as possible, each setting is only used by one user and only for one object.

Compared to FIG. 5a, FIG. 5b shows a stamp impression 13b which can be produced with an inventive hand stamp 1 comprising two separate QR codes of which one is the impression 7b of the stamp code 7 and the other is the impression 8b of the application code 8. When using a stamp code 7, the static part of the imprint surface, i.e. the static cliché is in particular configured and produced individually for each stamp. As a result, a larger multiplicity of stamp impressions can be produced overall since each setting of the type assembly can be used with each stamp code. The uniqueness of the stamp impression 13b is already ensured if the setting of the type assembly for the respective stamp code is used only once. According to one embodiment, the stamp code can uniquely identify a stamp; alternatively however, several stamps (e.g. of one user) can have the same stamp code wherein within this, relatively small, group of stamps the uniqueness of the setting of the type assembly is ensured. The advantage of this alternative is that by means of the marked objects, it cannot be identified which of several stamps of the same user was used for marking which otherwise could allow conclusions to be drawn as to the internal processes of this user.

FIG. 6a shows a stamp unit of a hand stamp 1 with an adjustable type assembly 4 having six type strips 9, each having different printing characters 5. The type assembly 4 according to FIG. 6a (and also that according to FIG. 2 or FIG. 3) has a bridge 11 with a supporting face 12. The supporting face 12 is provided to support a printing character 5 of an adjustable type strip 9 of the type assembly 4 set for a stamp impression 13. That is, the type strips 9 run transversely over the bridge 11 and are mounted slidingly on the supporting face 12 so that strip sections of the type strips 9 resting on the supporting face 12 are held in one plane. The width extension B of the supporting surface 12 in the direction R of the adjustment of the type strip 9 is greater than the extension E of the character or the printing character 5 in the same direction R. Thus, when setting the printing characters 5 of the type assembly 4, both the respective printing character 5 and also the position of the set printing character 5 relative to the static cliché 3 provided for the stamp impression 13, i.e. along the width extension B of the supporting face 12 can be set. Preferably the position of the set printing character 5 on the supporting face 12 is specified randomly. In the example of FIG. 6a, the type assembly 4 has six type strips 9 with numbers as characters or printing characters 5. According to FIG. 6a, the numbers can be arranged over the supporting face 12 offset with respect to one another in direction R. A stamp impression 13 with printing characters 5a or numbers printed offset with respect to one another in such a manner and with a static cliché 3, such as can be achieved with the stamp unit according to FIG. 2 is shown in FIG. 6b.

FIG. 7 shows schematically a flow diagram with process steps to be carried out by a user of the hand stamp 1 to produce a marking on the object which serves to authenticate an object. In step S1 a preferably multi-digit code, for example, a numerical code is set with the type assembly 4. The code can be checked for first-time allocation by means of a software program or the code is generated by a software program itself and displayed. In step S2 the object is stamped with the static cliché 3 and the printing characters 5 by the user of the hand stamp 1 in order to produce a stamp impression 13. In step S3 the stamp impression 13 alone can be recorded digitally, for example, scanned in or photographed and preferably checked for one-off allocation. In step S4 the entire object or at least that part of the object which is essential for verifying the authenticity of the object is recorded digitally, for example, scanned in or photographed to create a digital representation of the object. In this case, the object can also be recorded in a slightly distorted manner. Additional digital data can also be recorded and assigned to the digital representation of the object. In step S5 the digital representation of the object is optionally stored, i.e. uploaded, with the additionally recorded digital data on a storage medium accessible to an inspector, in particular in a database. In this case, firstly the authorization for the registration of a combination of the static cliché 3 used or a user identification assigned to the static cliché 3 is checked with a setting of the printing characters 5, e.g. using existing access data and authorizations of the user. If the necessary authorization exists, the combination of the static cliché 3 used or a user identification assigned to the static cliché with the at least one set printing character 5 used is registered and the registered combination is linked to the created and uploaded digital representation. The linking is used for the retrievability of the digital representation by means of the combination of static cliché or user identification and setting of the printing characters. The payment of a fee can also be associated with the uploading.

FIG. 8 shows schematically a flow diagram with process steps to be carried out by an inspector to authenticate an object. In step S10 the stamp impression 13, for example, a QR code is recorded digitally on the object to be authenticated, for example, scanned in or photographed. The application code 8 of the recorded stamp impression 13 preferably leads the inspector to an internet address at which a software program for checking the object for authenticity, i.e. a checking software, is provided. If this checking software is not already available on the reader used and is installed, in step S11 it can be loaded into the reader, for example, a smartphone of the inspector. In step S12 the recorded stamp impression 13 is processed by the checking software. Should it be found here that the stamp impression 13 could not be detected sufficiently accurately, the two-dimensional stamp code 7 alone can be recorded and the information depicted by the printing characters 5 can be input manually into the reader. In step S13 the inspector is informed by means of the checking software whether the combination of the stamp code 7 and the information depicted by the printing characters 5 is valid, i.e. an object had previously been registered by a user under this combination. Optionally access to the digital representation of the object in the database is only possible after payment of a fee. In this case, the inspector pays the required fee in step S14. In step S15 the digital representation of the object in the database is loaded onto a display device, for example the reader, in particular the smartphone of the inspector whereupon the inspector can make a comparison with the real object.

1. A hand stamp (1) comprising a stamp plate (2) having a static cliché (3) and comprising an adjustable type assembly (4) having different printing characters (5), wherein the static cliché (3) of the stamp plate (2) has a two-dimensional stamp code (7), wherein the type assembly (4) has a bridge (11) with a supporting face (12), which supporting face (12) is provided to support a printing character, set for a stamp impression (13), of an adjustable type strip (9) of the type assembly (4), and the width extension (B) of which in the direction (R) of adjustment of the type strip (9) is greater than the extension (E) of the printing character in the same direction (R).

2. The hand stamp (1) according to claim 1, wherein the two-dimensional stamp code (7) represents a unique user identification.

3. The hand stamp (1) according to claim 1, wherein the static cliché (3) additionally has a two-dimensional application code (8) which differs from the two-dimensional stamp code (7).

4. The hand stamp (1) according to claim 1, wherein the two-dimensional stamp code (7) and/or the two-dimensional application code (8) is a two-dimensional machine-readable character code, in particular a matrix code, preferably a OR code.

5. The hand stamp (1) according to claim 3, wherein the two-dimensional application code (8) represents an Internet address.

6. The hand stamp (1) according to claim 1, wherein the width extension (B) of the supporting face (12) is at least 1.5 times as large, preferably at least twice as large as the extension (E) of the printing character in the same direction (R).

7. The hand stamp (1) according to claim 1, wherein the type assembly (4) has at least two, preferably at least four independently adjustable type carriers (9), in particular with numbers and/or letters as printing characters (5).

8. A method for producing a marking serving to authenticate an object on the object, using the hand stamp (1) according to claim 1, wherein the method comprises:
setting at least one printing character (5) of the type assembly (4) for a stamp impression (13);
producing a stamp impression (13) of the static cliché (3) and the at least one set printing character (5) on the object;
creating a digital representation of the object having the stamp impression (13); and
registering a combination of the static cliché (3) with the at least one set printing character (5) and linking the registered combination with the created digital representation.

9. The method according to claim 8, wherein when registering, a user identification assigned to the static cliché (3) is linked to a digital representation of the set printing character (5).

10. The method according to claim 8, wherein before registering, an authorization linked to the static cliché (3) is checked for registering new connections with set printing characters (5).

11. The method according to claim 8, comprising
generating and displaying a specification of the at least one printing character (5) of the type assembly (4) to be set,
wherein the setting of the at least one printing character (5) takes place according to the displayed specification, and
wherein during registering a combination of the static cliché (3) with the generated specification of the printing character (5) is registered.

12. The method according to claim 11, wherein during setting both the printing character (5) of the type assembly (4) and also the position of the set printing character (5) in the impression relative to the static cliché (3) are set, wherein at least the position of the set printing character (5) is randomly specified.

13. The method according to claim 12, wherein during registering the position of the set printing character (5) in the impression relative to the static cliché (3) is registered.
